(19) United States
(12) Patent Application Publication
(10) Pub. No.: US 2023/0152821 A1
(43) Pub. Date: May 18, 2023

(54) METHOD AND SYSTEM FOR VEHICLE HEAD DIRECTION COMPENSATION

(71) Applicant: Industrial Technology Research Institute, Hsinchu (TW)

(72) Inventors: Yu-Kai Wang, Chiayi County (TW); Yuan-Chu Tai, Hsinchu City (TW); Chung-Hsien Wu, Hsinchu City (TW)

(73) Assignee: Industrial Technology Research Institute, Hsinchu (TW)

(21) Appl. No.: 17/555,521

(22) Filed: Dec. 20, 2021

(30) Foreign Application Priority Data
Nov. 16, 2021 (TW) 110142553

(51) Int. Cl. G05D 1/08; G05D 1/06; G06V 20/17

(52) U.S. Cl. CPC G05D 1/0808; G05D 1/0607; G06V 20/17; B64C 2201/122; B64C 39/024

(57) ABSTRACT

A method and a system for vehicle head direction compensation are disclosed. The method includes the following. A relative position between each of a plurality of sensors disposed on a vehicle and a plurality of base stations is obtained through the sensors and a relative coordinate system is established by a processor to obtain a vehicle head direction of the vehicle in the relative coordinate system and a deviation angle between an X-axis of the relative coordinate system and a true north azimuth. An angle compensation is performed by the processor on the vehicle head direction of the vehicle in the relative coordinate system based on the deviation angle.

### CROSS-REFERENCE TO RELATED APPLICATION

This application claims the priority benefit of Taiwanese application no. 110142553, filed on Nov. 16, 2021. The entirety of the above-mentioned patent application is hereby incorporated by reference herein and made a part of this specification.

### BACKGROUND

### Technical Field

The disclosure relates to a method and a system for vehicle head direction compensation.

### Description of Related Art

There are more than 23,000 bridges in Taiwan. If under bridge inspection is manually performed every year, it may be difficult to increase inspection efficiency because of time-consuming inspection operation, lack of inspection vehicles, and possible risks to public security.

The use of an unmanned vehicle for automated inspection operation can address the above issues. However, during the process of automated inspection operation using an unmanned vehicle, it is required to accurately know a head direction of the unmanned vehicle. Currently, an electronic compass (a magnetometer) is most frequently utilized to determine a head direction of an unmanned vehicle. However, when the electronic compass is utilized in an under bridge passage or in a tunnel, the magnetometer may be interfered with by electric power equipment or steel structures and become invalid. Therefore, how to design a method and a system for accurately obtaining the head direction of an unmanned vehicle in any environment is one of research topics for those skilled in the related field.

### SUMMARY

The exemplary embodiments of disclosure provide a method and a system for vehicle head direction compensation, in which angle compensation is performed on a head direction angle of an unmanned vehicle in a local coordinate system by using a true north azimuth after the local coordinate system is established.

According to an exemplary embodiment of the disclosure, a method for vehicle head direction compensation includes the following. A relative position between each of a plurality of sensors disposed on a vehicle and a plurality of base stations is obtained through the sensors and a relative coordinate system is established by a processor to obtain a vehicle head direction of the vehicle in the relative coordinate system and a deviation angle between an X-axis of the relative coordinate system and a true north azimuth. An angle compensation is performed by the processor on the vehicle head direction of the vehicle in the relative coordinate system based on the deviation angle.

According to an exemplary embodiment of the disclosure, a system for vehicle head direction compensation includes a plurality of base stations, a vehicle, a plurality of sensors, and a processor. The sensors are disposed on the vehicle. The processor is coupled to the sensors, obtains a relative position between each of the sensors and the base stations through the sensors and establishes a relative coordinate system to obtain a vehicle head direction of the vehicle in the relative coordinate system and a deviation angle between an X-axis of the relative coordinate system and a true north azimuth, and performs an angle compensation on the vehicle head direction of the vehicle in the relative coordinate system based on the deviation angle.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram of a system for vehicle head direction compensation according to an exemplary embodiment of the disclosure.

FIG. 2 is a flowchart of a method for vehicle head direction compensation according to an exemplary embodiment of the disclosure.

FIG. 3 and FIG. 4 are each a schematic diagram of a relative coordinate system according to an exemplary embodiment of the disclosure.

### DESCRIPTION OF THE EMBODIMENTS

The exemplary embodiments of the disclosure provide a method and a system for accurately obtaining an unmanned vehicle head direction. In the method and the system, the head direction of the unmanned vehicle can be mapped to a world coordinate system through a local positioning system, and an angle difference between the local positioning system and the true north azimuth can be compensated instantly. Accordingly, with the method and the system of the exemplary embodiments of the disclosure, a head direction angle of an unmanned vehicle can be accurately obtained in any environment, thus achieving correctly and fully automated driving by the unmanned vehicle to perform inspection operation, and preventing risks in manual inspection operation. The method and the system of the exemplary embodiments of the disclosure may be applied to inspection operation such as drone bridge inspection, drone outdoor engineering inspection, and drone tunnel inspection.

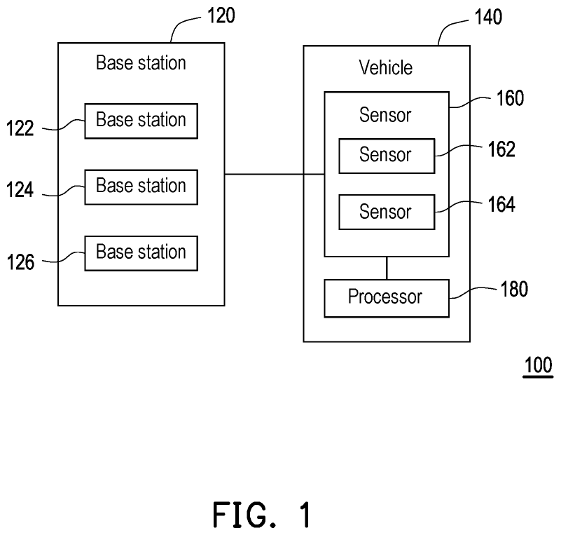

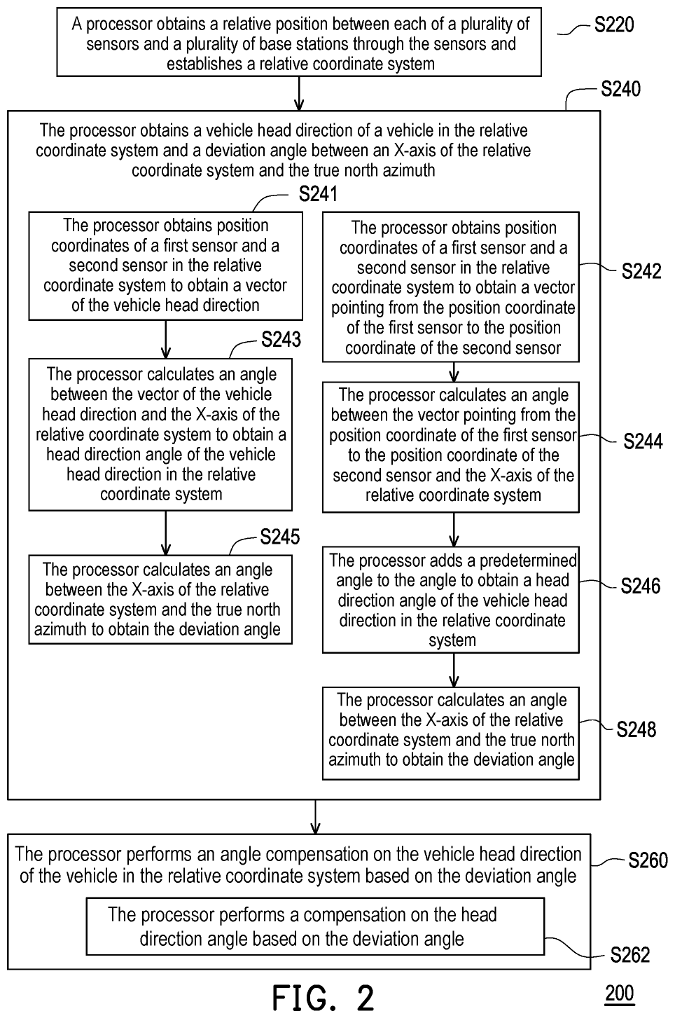

FIG. 1 is a block diagram of a system for vehicle head direction compensation according to an exemplary embodiment of the disclosure. Nonetheless, FIG. 1 is only for the ease of description, and is not intended to limit the disclosure. First, FIG. 1 introduces all the member and configuration relationships of the system for vehicle head direction compensation, of which the detailed functions in combination with FIG. 2 will be described.

With reference to FIG. 1, a system for vehicle head direction compensation 100 of this exemplary embodiment includes a plurality of base stations 120, a vehicle 140, a plurality of sensors 160, and a processor 180. The sensors 160 are disposed on the vehicle 140. The vehicle 140 is, for example, an unmanned aerial vehicle, which may be a drone, but is not limited thereto. The processor 180 is coupled to the sensors 160.

In an exemplary embodiment, the base stations 120 are set in the environment by the user in advance. In an exemplary embodiment, the processor 180 may be disposed on the vehicle 140, or may be another device independent of the vehicle 140.

It should be noted that the base stations 120 include at least three base stations, and the sensors 160 include at least two sensors. In addition, for simplicity of the description, in the system for vehicle head direction compensation 100 in this exemplary embodiment of FIG. 1, there are shown three base stations 122, 124, 126 and two sensors 162, 164 as examples. Nonetheless, those ordinarily skilled in the related field may appropriately adjust the numbers of base stations and sensors depending on the actual application circumstances, which are not limited by this exemplary embodiment.

The sensors 162 and 164 are, for example, radars, sonic sensing devices, or optical sensing devices, for example, optical radars, depth-of-field cameras, and image capture devices using light detection and ranging (LiDAR) among other devices having the function of sensing object distance. The sensors 162 and 164 are connected through a connection device (not shown) to the base stations 122, 124, 126 and the processor 180 in a wired or wireless manner. For the wired manner, the connection device may be an interface of Universal Serial Bus (USB), RS232, universal asynchronous receiver/transmitter (UART), internal integrated circuit (I2C), serial peripheral interface (SPI), display port, thunderbolt, or local area network (LAN), but is not limited thereto. For the wireless manner, the connection device may be a wireless fidelity (Wi-Fi) module, a wireless radio frequency identification (RFID) module, a Bluetooth module, an infrared module, a near-field communication (NFC) module, or a device-to-device (D2D) module, but is similarly not limited thereto.

The processor 180 is, for example, a central processing unit (CPU), or any other programmable general-purpose or special-purpose microprocessor, digital signal processor (DSP), programmable controller, application specific integrated circuit (ASIC), or other similar devices or a combination of these devices. In this exemplary embodiment, the processor 180 may load a computer program from a storage device (not shown) to execute a method for vehicle head direction compensation of an exemplary embodiment of the disclosure.

FIG. 2 is a flowchart of a method for vehicle head direction compensation according to an exemplary embodiment of the disclosure. With reference to FIG. 2 together, the method of this exemplary embodiment is adapted for the system for vehicle head direction compensation 100 of FIG. 1. Detailed steps of a method for vehicle head direction compensation 200 of the exemplary embodiment of the disclosure accompanied with the actuation relationship between the elements in the system for vehicle head direction compensation 100 will be described hereinafter.

First, in step S220, in the process of vehicle head direction compensation, the processor 180 first obtains a relative position between each of the sensors 162, 164 and the base stations 122, 124, 126 through the sensors 162, 164 and establishes a relative coordinate system. Specifically, the processor 180 obtains the relative position between each of the sensors 162, 164 and the base stations 122, 124, 126 through the sensors 162, 164 and establishes the relative coordinate system using an ultra wideband positioning technology.

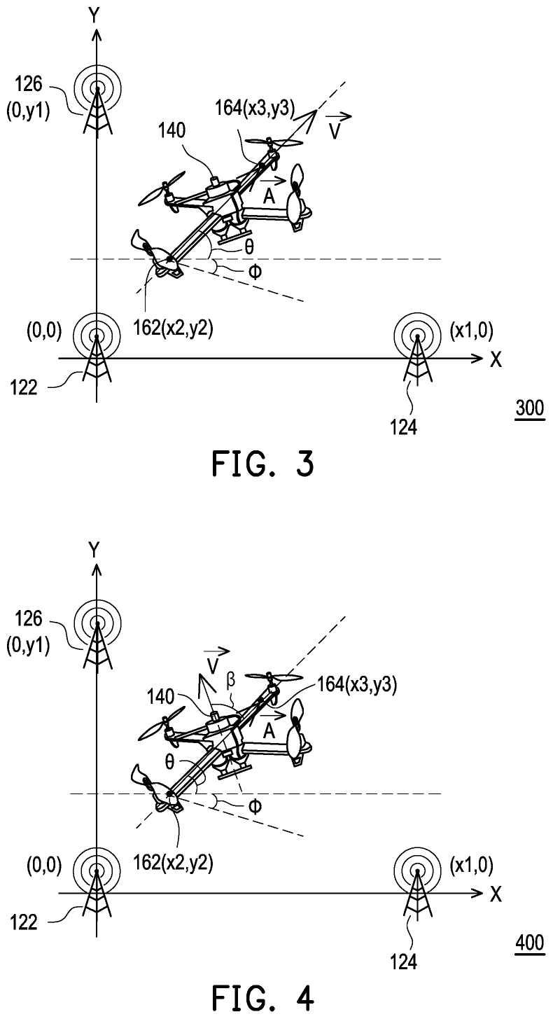

For example, FIG. 3 and FIG. 4 are each a schematic diagram of a relative coordinate system according to an exemplary embodiment of the disclosure. With reference to FIG. 3 and FIG. 4, the direction from the base station 122 to the base station 124 is an X-axis of relative coordinate systems 300 and 400, and the direction from the base station 122 to the base station 126 is a Y-axis of the relative coordinate systems 300 and 400. A position coordinate of the base station 122 is (0, 0), a position coordinate of the base station 124 is (x1, 0), and a position coordinate of the base station 126 is (0, y1). The sensor 162 and the sensor 164 are two coordinate points located in the relative coordinate systems 300 and 400.

Then, in step S240, the processor 180 obtains a vehicle head direction of the vehicle 140 in the relative coordinate system and a deviation angle between the X-axis of the relative coordinate system and the true north azimuth.

In an exemplary embodiment, the specific implementation steps of step S240 include step S241, step S243, and step S245, which accompanied with the relative coordinate system 300 of FIG. 3 will be exemplarily described hereinafter.

In step S241, the processor 180 obtains position coordinates of the sensor 162 and the sensor 164 in the relative coordinate system to obtain a vector of the vehicle head direction. To be specific, the processor 180 obtains the position coordinates of the sensor 162 and the sensor 164 in the relative coordinate system by triangulation positioning. For example, with reference to FIG. 3, the sensor 162 and the sensor 164 are both disposed on the central axis of the vehicle 140 for ease of obtaining the axial direction of the central axis. Nonetheless, those ordinarily skilled in the related field may appropriately change the setting positions of the sensors depending on the actual application circumstances. Even if the setting positions of the sensor 160 and the sensor 164 are changed, the axial direction of the central axis can still be obtained through calibration, which is not limited by this exemplary embodiment. In particular, in this exemplary embodiment, a vector \vec{V} of the vehicle head direction is the same as a vector \vec{A} pointing from the position coordinate of the sensor 162 to the position coordinate of the sensor 164. Here, the position coordinate of the sensor 162 is (x2, y2), and the position coordinate of the sensor 164 is (x3, y3), so it follows that the vector \vec{V} of the vehicle head direction is (x3-x2, y3-y2).

In step S243, the processor 180 calculates an angle between the vector of the vehicle head direction and the X-axis of the relative coordinate system to obtain a head direction angle of the vehicle head direction in the relative coordinate system. For example, with reference to FIG. 3, the processor 180 utilizes the function a tan 2 in the trigonometric functions to calculate and obtain that an angle between a ray pointing to (x3-x2, y3-y2) on the coordinate plane and the positive direction of the X-axis is θ.

In step S245, the processor 180 calculates an angle between the X-axis of the relative coordinate system and the true north azimuth to obtain the deviation angle. For example, with reference to FIG. 3, the processor 180 utilizes the trigonometric functions to calculate and obtain that the angle between the positive direction of the X-axis of the relative coordinate system 300 and the true north azimuth is ∅, which is namely the deviation angle.

In another exemplary embodiment, the specific implementation steps of step S240 include step S242, step S244, step S246, and step S248, which accompanied with the relative coordinate system 400 of FIG. 4 will be exemplarily described hereinafter.

In step S242, the processor 180 obtains the position coordinates of the sensor 162 and the sensor 164 in the relative coordinate system to obtain a vector pointing from the position coordinate of the sensor 162 to the position coordinate of the sensor 164. To be specific, the processor 180 obtains the position coordinates of the sensor 162 and the sensor 164 in the relative coordinate system by triangulation positioning. For example, with reference to FIG. 4, the sensor 162 and the sensor 164 are both disposed on the central axis of the vehicle 140 for ease of obtaining the axial direction of the central axis. Nonetheless, those ordinarily skilled in the related field may appropriately change the setting positions of the sensors depending on the actual application circumstances. Even if the setting positions of the sensor 160 and the sensor 164 are changed, the axial direction of the central axis can still be obtained through calibration, which is not limited by this exemplary embodiment. It should be particularly noted that, in this exemplary embodiment, the vector \vec{V} of the vehicle head direction is different from the vector \vec{A} pointing from the position coordinate of the sensor 162 to the position coordinate of the sensor 164. Here, the position coordinate of the sensor 162 is (x2, y2), and the position coordinate of the sensor 164 is (x3, y3), so it follows that the vector A pointing from the position coordinate of the sensor 162 to the position coordinate of the sensor 164 is (x3-x2, y3-y2).

In step S244, the processor 180 calculates an angle between the vector pointing from the position coordinate of the sensor 162 to the position coordinate of the sensor 164 and the X-axis of the relative coordinate system. For example, with reference to FIG. 4, the processor 180 utilizes the function a tan 2 in the trigonometric functions to calculate and obtain that the angle between the ray pointing to (x3-x2, y3-y2) on the coordinate plane and the positive direction of the X-axis is θ.

In step S246, the processor 180 adds a predetermined angle to the angle between the vector pointing from the position coordinate of the sensor 162 to the position coordinate of the sensor 164 and the X-axis of the relative coordinate system to obtain a head direction angle of the vehicle head direction in the relative coordinate system. In particular, the predetermined angle is the angle between the vector \vec{A} pointing from the position coordinate of the sensor 162 to the position coordinate of the sensor 164 and the vector \vec{V} of the vehicle head direction. In an exemplary embodiment, the predetermined angle may be preset, or may be calculated by the processor 180 based on information obtained by the sensor 162 and the sensor 164, which is not limited by the disclosure. For example, with reference to FIG. 4, the predetermined angle is β, so the head direction angle is namely θ+β.

In step S248, the processor 180 calculates an angle between the X-axis of the relative coordinate system and the true north azimuth to obtain the deviation angle. For example, with reference to FIG. 4, the processor 180 utilizes the trigonometric functions to calculate and obtain that the angle between the X-axis of the relative coordinate system 400 and the true north azimuth is ∅, which is namely the deviation angle.

Next, in step S260, the processor 180 performs an angle compensation on the vehicle head direction of the vehicle 140 in the relative coordinate system based on the deviation angle.

In this exemplary embodiment, the specific implementation steps of step S260 include step S262.

In step S262, the processor 180 performs a compensation on the head direction angle based on the deviation angle. For example, with reference to FIG. 3, the processor 180 utilizes the deviation angle ∅ to perform the compensation on the head direction angle θ. Accordingly, it follows that a head direction angle of the vehicle 140 in the world coordinate system is θ+∅. With reference to FIG. 4 also, the processor 180 utilizes the deviation angle ∅ to perform the compensation on the head direction angle θ+β. Accordingly, it follows that a head direction angle of the vehicle 140 in the world coordinate system is θ+β+∅.

In an exemplary embodiment, after the angle compensation on the vehicle head direction, the vehicle 140 performs a destination navigation.

It is worth noting that the specific order and/or hierarchy of the steps in the method of the exemplary embodiment of the disclosure are only exemplary. Based on design preferences, the specific order or hierarchy of the steps of the disclosed method or process may be rearranged while remaining within the scope of the exemplary embodiments of the disclosure. Therefore, those of ordinary skill in the related field will understand that various steps or actions are presented in a sample order in the method and skills of the exemplary embodiments of the disclosure, and unless expressly stated otherwise, the exemplary embodiments of the disclosure are not limited to the specific order or hierarchy presented.

In summary of the foregoing, in the method and the system for vehicle head direction compensation of the exemplary embodiments of the disclosure, the relative positions between the sensors and the base stations are utilized to establish the local coordinate system, and the angle between the X-axis of the local coordinate system and the true north azimuth is utilized to compensate the head direction angle of the unmanned vehicle in the local coordinate system, to obtain the correct head direction angle of the unmanned vehicle (i.e., the head direction angle in the world coordinate system). Accordingly, in the method and the system for vehicle head direction compensation of the exemplary embodiments of the disclosure, the head direction angle of the unmanned vehicle can be accurately obtained in any environment, thus achieving fully automated inspection operation by the unmanned vehicle.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A method for vehicle head direction compensation, the method comprising:
obtaining a relative position between each of a plurality of sensors disposed on a vehicle and a plurality of base stations through the sensors and establishing a relative coordinate system by a processor to obtain a vehicle head direction of the vehicle in the relative coordinate system and a deviation angle between an X-axis of the relative coordinate system and a true north azimuth; and
by the processor, performing an angle compensation on the vehicle head direction of the vehicle in the relative coordinate system based on the deviation angle.

2. The method according to claim 1, wherein the sensors comprise a first sensor and a second sensor, and obtaining the relative position between each of the sensors disposed on the vehicle and the base stations through the sensors and establishing the relative coordinate system by the processor to obtain the vehicle head direction of the vehicle in the relative coordinate system and the deviation angle between the X-axis of the relative coordinate system and the true north azimuth comprises:
obtaining position coordinates of the first sensor and the second sensor in the relative coordinate system by the processor to obtain a vector of the vehicle head direction;
calculating an angle between the vector of the vehicle head direction and the X-axis of the relative coordinate system by the processor to obtain a head direction angle of the vehicle head direction in the relative coordinate system; and
calculating an angle between the X-axis of the relative coordinate system and the true north azimuth by the processor to obtain the deviation angle.

3. The method according to claim 2, wherein performing the angle compensation on the vehicle head direction of the vehicle in the relative coordinate system by the processor based on the deviation angle comprises:
performing a compensation on the head direction angle by the processor based on the deviation angle.

4. The method according to claim 2, wherein the vector of the vehicle head direction is a vector pointing from the position coordinate of the first sensor to the position coordinate of the second sensor.

5. The method according to claim 2, wherein obtaining the position coordinates of the first sensor and the second sensor in the relative coordinate system by the processor comprises:
obtaining the position coordinates of the first sensor and the second sensor in the relative coordinate system by the processor by triangulation positioning.

6. The method according to claim 1, wherein the sensors comprise a first sensor and a second sensor, and obtaining the relative position between each of the sensors disposed on the vehicle and the base stations through the sensors and establishing the relative coordinate system by the processor to obtain the vehicle head direction of the vehicle in the relative coordinate system and the deviation angle between the X-axis of the relative coordinate system and the true north azimuth comprises:
obtaining position coordinates of the first sensor and the second sensor in the relative coordinate system by the processor to obtain a vector pointing from the position coordinate of the first sensor to the position coordinate of the second sensor;
calculating an angle between the vector pointing from the position coordinate of the first sensor to the position coordinate of the second sensor and the X-axis of the relative coordinate system by the processor;
adding a predetermined angle to the angle by the processor to obtain a head direction angle of the vehicle head direction in the relative coordinate system; and
calculating an angle between the X-axis of the relative coordinate system and the true north azimuth by the processor to obtain the deviation angle.

7. The method according to claim 6, wherein performing the angle compensation on the vehicle head direction of the vehicle in the relative coordinate system by the processor based on the deviation angle comprises:
performing a compensation on the head direction angle by the processor based on the deviation angle.

8. The method according to claim 1, wherein the base stations comprise at least three base stations, and obtaining the relative position between each of the sensors disposed on the vehicle and the base stations through the sensors by the processor comprises:
obtaining the relative position between each of the sensors and the base stations by the processor using an ultra wideband positioning technology.

9. The method according to claim 1, further comprising:
after the angle compensation on the vehicle head direction, performing a destination navigation by the vehicle.

10. A system for vehicle head direction compensation, the system comprising:
a plurality of base stations;
a vehicle;
a plurality of sensors, disposed on the vehicle; and
a processor, coupled to the sensors, obtaining a relative position between each of the sensors and the base stations through the sensors and establishing a relative coordinate system to obtain a vehicle head direction of the vehicle in the relative coordinate system and a deviation angle between an X-axis of the relative coordinate system and a true north azimuth, and performing an angle compensation on the vehicle head direction of the vehicle in the relative coordinate system based on the deviation angle.

11. The system according to claim 10, wherein the sensors comprise a first sensor and a second sensor, and the processor:
obtains position coordinates of the first sensor and the second sensor in the relative coordinate system to obtain a vector of the vehicle head direction;
calculates an angle between the vector of the vehicle head direction and the X-axis of the relative coordinate system to obtain a head direction angle of the vehicle head direction in the relative coordinate system; and
calculates an angle between the X-axis of the relative coordinate system and the true north azimuth to obtain the deviation angle.

12. The system according to claim 11, wherein the processor:
performs a compensation on the head direction angle based on the deviation angle.

13. The system according to claim 11, wherein the vector of the vehicle head direction is a vector pointing from the position coordinate of the first sensor to the position coordinate of the second sensor.

14. The system according to claim 11, wherein the processor obtains the position coordinates of the first sensor and the second sensor in the relative coordinate system by triangulation positioning.

15. The system according to claim 10, wherein the sensors comprise a first sensor and a second sensor, and the processor:
obtains position coordinates of the first sensor and the second sensor in the relative coordinate system to obtain a vector pointing from the position coordinate of the first sensor to the position coordinate of the second sensor;
calculates an angle between the vector pointing from the position coordinate of the first sensor to the position coordinate of the second sensor and the X-axis of the relative coordinate system;
adds a predetermined angle to the angle to obtain a head direction angle of the vehicle head direction in the relative coordinate system; and
calculates an angle between the X-axis of the relative coordinate system and the true north azimuth to obtain the deviation angle.

16. The system according to claim 15, wherein the processor:
performs a compensation on the head direction angle based on the deviation angle.

17. The system according to claim 10, wherein the base stations comprise at least three base stations, and the processor obtains the relative position between each of the sensors and the base stations using an ultra wideband positioning technology.

18. The system according to claim 10, wherein after the angle compensation on the vehicle head direction, the vehicle performs a destination navigation.
